(19) United States
(12) Patent Application Publication
(10) Pub. No.: US 2024/0029689 A1
(43) Pub. Date: Jan. 25, 2024

(54) MUTE

(71) Applicant: ERIC SUNG-UN CHOE, Qingdao (CN)

(72) Inventor: ERIC SUNG-UN CHOE, Qingdao (CN)

(21) Appl. No.: 17/954,510

(22) Filed: Sep. 28, 2022

(30) Foreign Application Priority Data
Jul. 22, 2022 (CN) 202221901117.3

(51) Int. Cl. G10D 9/06

(52) U.S. Cl. CPC G10D 9/06

(57) ABSTRACT

The present disclosure provides a mute, belongs to a field of musical instruments, the mute includes a mute body, the mute body is narrow at top and wide at bottom, and is in a shape of a gourd, the mute body includes an inlet half-body and an outlet half-body, a surface of the mute body is patterned, and the surface of the mute body is sanded and polished to form a smooth surface, a surface of the inlet half-body is bonded with a plurality of elastic members.

### TECHNICAL FIELD

The present disclosure relates to a field of musical instruments, and in particularly to a mute.

### BACKGROUND

Mutes are one of auxiliary musical instruments. There are two kinds of the mutes in the prior art, one kind of the mutes is made of metal, and most of them are aluminum products, which are completely configured to reduce a volume. In addition, another type of the mutes is mostly made of rubber, and has many shapes sold in market, however, most of them are round, and an effect of reducing the volume is not obvious.

At present, many mutes on the market are relatively bulky, are prone to deformation when dropped on ground, and are prone to damage upon collision, and an effect of sound quality is poor.

### SUMMARY

In view of shortcomings mentioned above, a purpose of the present disclosure is to provide a mute, so as to solve problems proposed in the background.

In order to solve the above problems, the present disclosure adopts following technical solutions:

The present disclosure provides a mute, the mute includes a mute body, the mute body is narrow at top and wide at bottom, and is in a shape of a gourd, the mute body includes an inlet half-body and an outlet half-body, where the inlet half-body is small and circular and the outlet half-body is large and circular. A surface of the mute body is patterned, and the surface of the mute body is sanded and polished to form a smooth surface, a surface of the inlet half-body is bonded with a plurality of elastic members.

Optional, the mute body is integrally formed by splicing a left half part and a right half part, and is then sanded and polished to form a smooth surface.

Optional, a material of the mute body is carbon fiber.

Optional, the inlet half-body is inclined from bottom to top by 10° to 30°.

Optional, the elastic members are EVA sponges.

The present disclosure has the following beneficial effects:

1. The surface of the mute of the present disclosure has patterns and is sanded and polished, an appearance of the mute is beautiful, delicate, smooth, and not prone to be damage.

2. The material of the carbon fiber is adopted in the present disclosure, so that a weight of the mute is greatly reduced, the mute is light and portable to use and carry, and the effect of sound quality is improved.

3. According to the present disclosure, the plurality of elastic members are bonded around the surface of the inlet half-body, which is able to effectively protect the inlet half-body, prevent the inlet half-body from dropping and being broken, and the inlet half-body is sturdier and more durable.

### DESCRIPTION OF DRAWINGS

In order to more clearly explain the technical solutions in the embodiments of the present disclosure, the following briefly introduces the drawings used in descriptions of the embodiments. Obviously, the drawings in the following description are only some embodiments of the present disclosure. For those skilled in the art, other drawings may be obtained based on these drawings without creative work.

FIG. 1 is a schematic structural diagram of a mute of a first embodiment provided by an embodiment of the present disclosure.

FIG. 2 is a schematic structural diagram of a mute of a second embodiment provided by an embodiment of the present disclosure.

### BRIEF DESCRIPTION OF THE DRAWINGS

1. mute body; 2. inlet half-body; 3. outlet half-body; 4. elastic member.

### DETAILED DESCRIPTION

Technical solutions in the embodiments of the present disclosure are clearly and completely described below in conjunction with the accompanying drawings in the embodiments of the present disclosure. Obviously, the described embodiments are only parts of the embodiments of the present disclosure, rather than all the embodiments. Based on the embodiments of the present disclosure, all other embodiments obtained by those of ordinary skill in the art without creative work shall fall within the protection scope of the present disclosure.

In the descriptions of the present disclosure, the terms “upper”, “lower”, “front”, “rear”, “left”, “right”, “top”, “bottom”, “inner”, “outer”, and other indicated directions or the position relation are based on the orientation or position relation shown in the drawings and are only for convenience of describing the present disclosure and simplification of the description, rather than indicating or implying that indicated apparatus or elements referred to have a specific orientation, be constructed and operated in a specific orientation, so that the above directions of the present disclosure cannot be understood as limitations.

### A First Embodiment

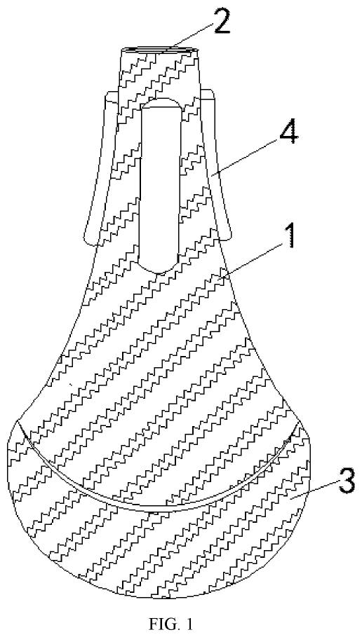

As shown in FIG. 1, the present disclosure provides a mute, the mute includes a mute body 1, the mute body 1 is narrow at top and wide at bottom, and is in a shape of a gourd, the mute body 1 includes an inlet half-body 2 and an outlet half-body 3, where the inlet half-body is small and circular and the outlet half-body is large and circular. A surface of the mute body 1 is patterned, and the surface of the mute body 1 is sanded and polished to form a smooth surface, a plurality of elastic members 4 is bonded around a surface of the inlet half-body 2.

### A Second Embodiment

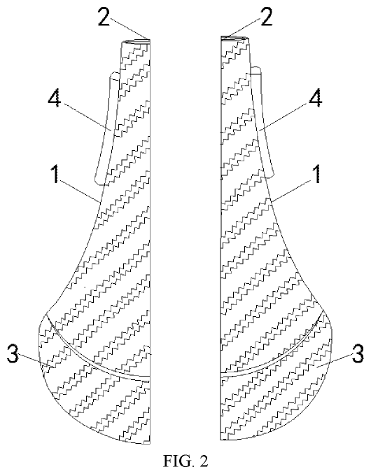

As shown in FIG. 2, the present disclosure provides a mute, the mute body 1 is integrally formed by splicing a left half part and a right half part, and is then sanded and polished to form a smooth surface.

Furthermore, a material of the mute body 1 is carbon fiber, which makes the mute sturdier and more durable, is resistant to dropping, is not prone to deformation, and also does not affect the sound quality.

Furthermore, the inlet half-body 2 is inclined from bottom to top by 10° to 30°.

Furthermore, the elastic members 4 are EVA sponges.

Working principle of the present disclosure is as follows.

The surface of the mute of the present disclosure has patterns and is sanded and polished, the mute has a beautiful appearance and is not prone to damage.

The material of the carbon fiber is adopted in the present disclosure, so that a weight of the mute is greatly reduced, the mute is light and portable to use and carry, and the effect of sound quality is improved. The plurality of elastic members 4 are bonded around the surface of the inlet half-body 2, which is able to effectively protect the inlet half-body, prevent the inlet half-body from dropping and being broken, and the inlet half-body is sturdier and more durable.

Obviously, those skilled in the art may make various modifications and variations to the present disclosure without departing from spirit and scope of the present disclosure. Thus, if these modifications and variations fall within the scope of the claims of the present disclosure and their equivalent technologies, the present disclosure is also intended to include these modifications and variations.

What is claimed is:

1. A mute, comprising:
a mute body;
wherein the mute body is narrow at top and wide at bottom, and is in a shape of a gourd, a surface of the mute body is patterned, and the surface of the mute body is sanded and polished to form a smooth surface;
wherein the mute body comprises:
an inlet half-body; and
an outlet half-body;
wherein the inlet half-body is small and circular, the outlet half-body is large and circular, and a plurality of elastic members is bonded around a surface of the inlet half-body.

2. The mute according to claim 1, wherein the mute body is integrally formed by splicing a left half part and a right half part.

3. The mute according to claim 1, wherein a material of the mute body is carbon fiber.

4. The mute according to claim 1, wherein the inlet half-body is inclined from bottom to top by 10° to 30°.

5. The mute according to claim 1, wherein the elastic members are EVA sponges.
